(19) United States
(12) Patent Application Publication
(10) Pub. No.: US 2025/0218092 A1
(43) Pub. Date: Jul. 3, 2025

(54) LINEAR BLEND SKINNING RIG FOR ANIMATION

(71) Applicant: Roblox Corporation, San Mateo, CA (US)

(72) Inventors: Maurice Kyojin CHU, Redwood City, CA (US); Ian SACHS, Corte Madera, CA (US); Dario KNEUBUHLER, Lucerne (CH)

(73) Assignee: Roblox Corporation, San Mateo, CA (US)

(21) Appl. No.: 18/990,744

(22) Filed: Dec. 20, 2024

Related U.S. Application Data
(60) Provisional application No. 63/616,487, filed on Dec. 29, 2023.

(51) Int. Cl. G06T 13/40

(52) U.S. Cl. CPC G06T 13/40

(57) ABSTRACT

The present disclosure provides techniques for automatically computing a linear blend skinning (LBS) rig. Most mesh vertices do not change positions from neutral pose to another pose (e.g., the mesh vertices at the top and back of the head). Thus, the present Smooth Skinning Decomposition for Rigid Bones (SSDR) technique determines joint transforms and skinning weights using vertex-joint sets in which a vertex i is influenced by joint j.

### CROSS-REFERENCE TO RELATED APPLICATIONS

This application is a non-provisional application that claims priority under 35 U.S.C. § 119(e) to U.S. Provisional Patent Application No. 63/616,487, filed on Dec. 29, 2023, the contents of which are hereby incorporated by reference herein in its entirety.

### TECHNICAL FIELD

Embodiments relate generally to online virtual experience platforms, and more particularly, to methods, systems, and computer readable media for dynamic head generation for animation.

### BACKGROUND

Online platforms, such as virtual experience platforms and online gaming platforms, can include head-rendering models that guide a user in creating a new avatar head for animation.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, a computer-implemented method to generate a linear blend skinning (LBS) rig for animation is provided. The method may include, for each pose p of a plurality of poses P and for each joint k of a plurality of joints J, determining, by a processor, a set of vertex-joint pairs in which a joint j of the plurality of joints J has influence over a vertex i in the pose p. The method may include, for each pose p of a plurality of poses P and for each joint k of a plurality of joints J, determining, by the processor, a corresponding first LBS coefficient β_{i,j}^{(p)} for each vertex-joint pair in the set of vertex-joint pairs based on a rotational transform Rⱼ^{(p)} of the joint j, an initial vertex position vᵢ⁽⁰⁾ of the vertex i in a neutral pose, and a translational transform Tⱼ^{(p)} of the joint j. The method may include, for each pose p of a plurality of poses P and for each joint k of a plurality of joints J, determining, by the processor, a corresponding second LBS coefficient γᵢ^{(p)} for each vertex i in the set of vertex-joint pairs by summing first LBS coefficients β_{i,j}^{(p)} for each vertex-joint pair that correspond to that respective vertex i, where i=1, . . . , N, where Nis a total number of vertices. The method may include, for each pose p of a plurality of poses P and for each joint k of a plurality of joints J, determining, by the processor, a corresponding third LBS coefficient α_{i,k}^{(p)} for each vertex i and each joint k based on a final vertex position vᵢ^{(p)} of the vertex i in the pose p, and the corresponding second LBS coefficient γᵢ^{(p)} for vertex i, and a fourth LBS coefficient β_{i,k}^{(p)} corresponding to the vertex i and the joint k. The method may include, for each pose p of a plurality of poses P and for each joint k of a plurality of joints J, determining, by the processor, a rotational transform Rₖ^{(p)} and a translational transform Tₖ^{(p)} for the joint k based on the corresponding third LBS coefficient α_{i,k}^{(p)} for the joint k. The method may include, for each pose p of a plurality of poses P and for each joint k of a plurality of joints J, updating, by the processor, the rotational transform Rₖ^{(p)} and the translational transform Tₖ^{(p)} for each joint k based on a learning rate λ. The method may include, for each pose p of a plurality of poses P and for each joint k of a plurality of joints J, determining, by the processor, a final rotational transform and a final translational transform for joint k based on the rotational transform Rₖ^{(p)} and the translational transform Tₖ^{(p)} updated based on the learning rate λ. The method may include rendering, by the processor, an avatar head based in the pose p based on the final rotational transform and the final translational transform.

In some implementations, the method may include, for each pose p of a plurality of poses P and for each joint k of a plurality of joints J, determining, by the processor, a set of final skinning weights for each vertex-joint pair in the set of vertex-joint pairs based on the final rotational transform and the final translational transform for each joint k of the plurality of joints J.

In some implementations, the determining the set of vertex-joint pairs in which a joint j of the plurality of joints J has influence over the vertex i in the pose p may include determining, by the processor, a feature vector for the vertex i based on the initial vertex position vᵢ⁽⁰⁾ of the vertex i in the neutral pose and the final vertex position vᵢ^{(p)} of the vertex i in the pose p for each of the plurality of poses P. In some implementations, the set of vertex-joint pairs may be determined based on the feature vector.

In some implementations, the method may include assigning, by the processor, an initial skinning weight wᵢⱼ to each vertex-joint pair in the set of vertex-joint pairs to a value of 1.

In some implementations, the corresponding first LBS coefficient β_{i,j}^{(p)} for each vertex-joint pair in the set of vertex-joint pairs may be determined by solving β_{i,j}^{(p)}=wᵢⱼ(Rⱼ^{(p)}vᵢ⁽⁰⁾+Tⱼ^{(p)}).

In some implementations the corresponding second LBS coefficient γᵢ^{(p)} for each vertex i in the set of vertex-joint pairs may be determined by solving

$${γ}_{i}^{( p )} = {\sum }_{j : {w}_{ij} > 0} {β}_{i , j}^{( p )} .$$

In some implementations the corresponding third LBS coefficient α_{i,k}^{(p)} for each vertex i and each joint k may be determined by solving α_{i,k}^{(p)}=vᵢ^{(p)}−γᵢ^{(p)}+β_{i,k}^{(p)}.

In some implementations, the rotational transform Rₖ^{(p)} and a translational transform Tₖ^{(p)} for the joint k may be determined based on

$${min}_{{R}_{k}^{( p )} , {T}_{k}^{( p )}} {w}_{ik}^{2} {‖ ( {R}_{k}^{( p )} {v}_{i}^{( 0 )} + {T}_{k}^{( p )} ) - \frac{{α}_{i , k}^{( p )}}{{w}_{ik}} ‖}^{2} .$$

According to another aspect of the present disclosure, computing device for generating an LBS rig is provided. The computing device may include a processor and memory storing instructions. The memory storing instructions, which when executed by the processor, cause the processor to perform operations that may include, for each pose p of a plurality of poses P and for each joint k of a plurality of joints J, determine a set of vertex-joint pairs in which a joint j of the plurality of joints J has influence over a vertex i in the pose p. The memory storing instructions, which when executed by the processor, cause the processor to perform operations that may include, for each pose p of a plurality of poses P and for each joint k of a plurality of joints J, determining a corresponding first LBS coefficient β_{i,j}^{(p)} for each vertex-joint pair in the set of vertex-joint pairs based on a rotational transform Rⱼ^{(p)} of the joint j, an initial vertex position vᵢ⁽⁰⁾ of the vertex i in a neutral pose, and a translational transform Tⱼ^{(p)} of the joint j. The memory storing instructions, which when executed by the processor, cause the processor to perform operations that may include, for each pose p of a plurality of poses P and for each joint k of a plurality of joints J, determining a corresponding second LBS coefficient γᵢ^{(p)} for each vertex I in the set of vertex-joint pairs by summing first LBS coefficients β_{i,j}^{(p)} for each vertex-joint pair that correspond to that respective vertex i, where i=1, . . . , N, where N is a total number of vertices. The memory storing instructions, which when executed by the processor, cause the processor to perform operations that may include, for each pose p of a plurality of poses P and for each joint k of a plurality of joints J, determining a corresponding third LBS coefficient α_{i,k}^{(p)} for each vertex i and each joint k based on a final vertex position vᵢ^{(p)} of the vertex i in the pose p, and the corresponding second LBS coefficient γᵢ^{(p)} for vertex i, and a fourth LBS coefficient β_{i,k}^{(p)} corresponding to the vertex i and the joint k. The memory storing instructions, which when executed by the processor, cause the processor to perform operations that may include, for each pose p of a plurality of poses P and for each joint k of a plurality of joints J, determining a rotational transform Rₖ^{(p)} and a translational transform \hat{T}ₖ^{(p)} for the joint k based on the corresponding third LBS coefficient α_{i,k}^{(p)} for the joint k. The memory storing instructions, which when executed by the processor, cause the processor to perform operations that may include, for each pose p of a plurality of poses P and for each joint k of a plurality of joints J, updating the rotational transform Rₖ^{(p)} and the translational transform Tₖ^{(p)} for each joint k based on a learning rate λ. The memory storing instructions, which when executed by the processor, cause the processor to perform operations that may include, for each pose p of a plurality of poses P and for each joint k of a plurality of joints J, determining a final rotational transform and a final translational transform for joint k based on the rotational transform Rₖ^{(p)} and the translational transform Tₖ^{(p)} updated based on the learning rate λ. The memory storing instructions, which when executed by the processor, cause the processor to perform operations that may include rendering an avatar head based in the pose p based on the final rotational transform and the final translational transform.

In some implementations, the operations may further include, for each pose p of a plurality of poses P and for each joint k of a plurality of joints J, determining a set of final skinning weights for each vertex-joint pair in the set of vertex-joint pairs based on the final rotational transform and the final translational transform for each joint k of the plurality of joints J.

In some implementations, the determining the set of vertex-joint pairs in which a joint j of the plurality of joints J has influence over the vertex i in the pose p may include determining a feature vector for the vertex i based on the initial vertex position vᵢ⁽⁰⁾ of the vertex i in the neutral pose and the final vertex position vᵢ^{(p)} of the vertex i in the pose p for each of the plurality of poses P, the set of vertex-joint pairs being determined based on the feature vector.

In some implementations, the operations may include assigning an initial skinning weight wᵢⱼ to each vertex-joint pair in the set of vertex-joint pairs to a value of 1.

In some implementations, the corresponding first LBS coefficient β_{i,j}^{(p)} for each vertex-joint pair in the set of vertex-joint pairs may be determined by solving β_{i,j}^{(p)}=wᵢⱼ(Rⱼ^{(p)}vᵢ⁽⁰⁾+Tⱼ^{(p)}).

In some implementations, the corresponding second LBS coefficient γᵢ^{(p)} for each vertex i in the set of vertex-joint pairs is computed by solving

$${γ}_{i}^{( p )} = {\sum }_{j : {w}_{ij} > 0} {β}_{i , j}^{( p )} .$$

In some implementations, the corresponding third LBS coefficient α_{i,k}^{(p)} for each vertex i and each joint k is determined by solving α_{i,k}^{(p)}=vᵢ^{(p)}−γᵢ^{(p)}+β_{i,k}^{(p)}.

In some implementations, the rotational transform Rₖ^{(p)} and a translational transform Tₖ^{(p)} for the joint k is determined based on

$${min}_{{R}_{k}^{( p )} , {T}_{k}^{( p )}} {w}_{ik}^{2} {‖ ( {R}_{k}^{( p )} {v}_{i}^{( 0 )} + {T}_{k}^{( p )} ) - \frac{{α}_{i , k}^{( p )}}{{w}_{ik}} ‖}^{2} .$$

According to a further aspect of the present disclosure a non-transitory computer-readable medium storing instructions is provided. The instructions, which when executed by a processor, cause the processor to perform operations that include, for each pose p of a plurality of poses P and for each joint k of a plurality of joints J, determining a set of vertex-joint pairs in which a joint j of the plurality of joints J has influence over a vertex i in the pose p. The instructions, which when executed by a processor, cause the processor to perform operations that include, for each pose p of a plurality of poses P and for each joint k of a plurality of joints J, determining a corresponding first LBS coefficient β_{i,j}^{(p)} for each vertex-joint pair in the set of vertex-joint pairs p) based on a rotational transform Rⱼ₍ₚ₎ of the joint j, an initial vertex position vᵢ⁽⁰⁾ of the vertex i in a neutral pose, and a translational transform Tⱼ^{(p)} of the joint j. The instructions, which when executed by a processor, cause the processor to perform operations that include, for each pose p of a plurality of poses P and for each joint k of a plurality of joints J, determining a corresponding second LBS coefficient γᵢ^{(p)} for each vertex i in the set of vertex-joint pairs by summing first LBS coefficients β_{i,j}^{(p)} for each vertex-joint pair that correspond to that respective vertex i, where i=1, . . . , N, where N is a total number of vertices. The instructions, which when executed by a processor, cause the processor to perform operations that include, for each pose p of a plurality of poses P and for each joint k of a plurality of joints J, determining a corresponding third LBS coefficient α_{i,k}^{(p)} for each vertex i and each joint k based on a final vertex position vᵢ^{(p)} of the vertex i in the pose p, and the corresponding second LBS coefficient γᵢ^{(p)} for vertex i, and a fourth LBS coefficient β_{i,k}^{(p)} corresponding to the vertex i and the joint k. The instructions, which when executed by a processor, cause the processor to perform operations that include, for each pose p of a plurality of poses P and for each joint k of a plurality of joints J, determining a rotational transform Rₖ^{(p)} and a translational transform \hat{T}ₖ^{(p)} for the joint k based on the corresponding third LBS coefficient α_{i,k}^{(p)} for the joint k. The instructions, which when executed by a processor, cause the processor to perform operations that include, for each pose p of a plurality of poses P and for each joint k of a plurality of joints J, updating the rotational transform Rₖ^{(p)} and the translational transform Tₖ^{(p)} for each joint k based on a learning rate λ. The instructions, which when executed by a processor, cause the processor to perform operations that include, for each pose p of a plurality of poses P and for each joint k of a plurality of joints J, determining a final rotational transform and a final translational transform for joint k based on the rotational transform Rₖ^{(p)} and the translational transform Tₖ^{(p)} updated based on the learning rate λ. The instructions, which when executed by a processor, cause the processor to perform operations that include rendering an avatar head based in the pose p based on the final rotational transform and the final translational transform.

In some implementations, the instructions, which when executed by the processor, may further cause the processor to perform operations that include, operations may further include, for each pose p of a plurality of poses P and for each joint k of a plurality of joints J, determining a set of final skinning weights for each vertex-joint pair in the set of vertex-joint pairs based on the final rotational transform and the final translational transform for each joint k of the plurality of joints J.

In some implementations, determining the set of vertex-joint pairs in which a joint j of the plurality of joints J has influence over the vertex i in the pose p may include determining a feature vector for the vertex i based on the initial vertex position vᵢ⁽⁰⁾ of the vertex i in the neutral pose and the final vertex position vᵢ^{(p)} of the vertex i in the pose p for each of the plurality of poses P, the set of vertex-joint pairs being determined based on the feature vector.

In some implementations, the operations may further include assigning an initial skinning weight wᵢⱼ to each vertex-joint pair in the set of vertex-joint pairs to a value of 1.

In some implementations, the corresponding first LBS coefficient β_{i,j}^{(p)} for each vertex-joint pair in the set of vertex-joint pairs may be determined by solving β_{i,j}^{(p)}=wᵢⱼ(Rⱼ^{(p)}vᵢ⁽⁰⁾+Tⱼ^{(p)}).

In some implementations, the corresponding second LBS coefficient γᵢ^{(p)} for each vertex i in the set of vertex-joint pairs is computed by solving

$${γ}_{i}^{( p )} = {\sum }_{j : {w}_{ij} > 0} {β}_{i , j}^{( p )} .$$

In some implementations, the corresponding third LBS coefficient α_{i,k}^{(p)} for each vertex i and each joint k is determined by solving α_{i,k}^{(p)}=vᵢ^{(p)}−γᵢ^{(p)}+β_{i,k}^{(p)}.

In some implementations, the rotational transform Rₖ^{(p)} and a translational transform Tₖ^{(p)} for the joint k is determined based on

$${min}_{{R}_{k}^{( p )} , {T}_{k}^{( p )}} {w}_{ik}^{2} {‖ ( {R}_{k}^{( p )} {v}_{i}^{( 0 )} + {T}_{k}^{( p )} ) - \frac{{α}_{i , k}^{( p )}}{{w}_{ik}} ‖}^{2} .$$

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a detailed block diagram of the avatar-head modeling component of FIG. 1, in accordance with some implementations.

FIGS. 3A-3C are schematics of an example visualization of a deformation-prediction model for an avatar head, in accordance with some implementations.

FIG. 4A is a block diagram of a conditional diffusion network, in accordance with some implementations.

FIG. 4B is a block diagram of a global encoder of the conditional diffusion network of FIG. 4A, in accordance with some implementations.

FIG. 4C is a block diagram of a conditional diffusion network block of the conditional diffusion network of FIG. 4A, in accordance with some implementations.

FIG. 5 is a schematic of an example visualization of a Smooth Skinning Decomposition for Rigid Bones (SSDR) model for an avatar head, in accordance with some implementations.

FIG. 6A is a schematic of an example visualization of the caging-computational path that uses landmark detection, in accordance with some implementations.

FIG. 6B is a schematic of an example visualization of a cage fitted to the head mesh by a caging-model component using landmark detection, in accordance with some implementations.

FIG. 6C is a schematic of an example visualization of the caging-computational path that uses UV regression, in accordance with some implementations.

FIGS. 7A and 7B are a flowchart of an example method of LBS generation for animation, in accordance with some implementations.

FIG. 8 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various embodiments are described herein in the context of three-dimensional (3D) avatars that are used in a 3D virtual experience or environment. Some implementations of the techniques described herein may be applied to various types of 3D environments, such as a virtual reality (VR) conference, a 3D session (e.g., an online lecture or other type of presentation involving 3D avatars), a virtual concert, an augmented reality (AR) session, or in other types of 3D environments that may include one or more users that are represented in the 3D environment by one or more 3D avatars.

In some aspects, systems and methods are provided for manipulating 3D assets and creating new practical 3D assets. For example, practical 3D assets are 3D assets that are one or more of: easy to animate with low computational load, suitable for visual presentation in a virtual environment on a client device of any type, suitable for multiple different forms of animation, suitable for different skinning methodologies, suitable for different skinning deformations, suitable for different caging methodologies, and/or suitable for animation on various client devices. Online platforms, such as online virtual experience platforms, generally provide an ability to create, edit, store, and otherwise manipulate virtual items, virtual avatars, and other practical 3D assets to be used in virtual experiences.

For example, virtual experience platforms may include user-generated content or developer-generated content (each referred to as “UGC” herein). The UGC may be stored and implemented through the virtual experience platform, for example, by allowing users to search and interact with various virtual elements to create avatars and other items. Users may select and rearrange various virtual elements from various virtual avatars and 3D models to create new models and avatars. Avatar creators can create character heads with geometries of any desired/customized shape and size and publish the heads in a head library hosted by the virtual experience platform.

At runtime during a virtual experience or other 3D session, a user accesses the head library to select a particular head (including various parts such as eyes, lips, nose, ears, hair, facial hair, etc.), and to rearrange the head (or parts thereof). According to implementations described herein, the virtual experience platform may take as input the overall model of the head (or parts thereof) and infer a skeletal structure that allows for appropriate motion (e.g., joint movement, rotation, etc.). In this manner, many different avatar-head parts may be rearranged to enable dynamic avatar head creation without detracting from a user experience.

The embodiments described herein are based on the concept of meshes and rigs. As used herein, the term “mesh” refers to graphical representations of head parts (e.g., eyes, nose, lips, ears, chin, cheeks, ears, forehead, etc.) and can be of arbitrary shape, size, and geometric topology. The term “rig” refers to a virtual armature made up of a plurality of joints that are used to animate (pose) the mesh. The rig has a strong correspondence to the corresponding vertices of the mesh.

To animate a character, a creator first needs to generate a rig (also referred to herein as a “Linear Blend Skinning (LBS) rig”) that includes joints and skinning weights. There are many things that go into creating a successful rig. One of the most important is properly skinning the rig to the avatar head. Without skinning, the mesh will not deform correctly, and the animation of the avatar's face will lack realism. “Skinning” refers to the placement and correlation of joints with respect to the mesh. This means that the joints have influence on the vertices on the mesh and move them according to various poses. Skinning is vital for not only creating an avatar that moves accurately, but also one that deforms properly.

Skinning generally involves two operations: binding and weight painting. Binding is the process by which the joints are positioned (or “bound”) with respect to the mesh. Once the joints are bound to the mesh, skinning weight painting is performed to manually assign the proper weighted influence each joint has on the different vertices of the mesh. For instance, the joint around the eye of a character will most likely only control that area. If the eye joint were to move and influence the vertices associated with the mouth, the pose would lack realism. Skinning is typically done by hand. Because a rig is generally made up of hundreds of individual joints, and the joints each influence a different combination of vertices of the mesh in different ways, some skinning techniques use an undue number of matrix multiplications due to the number of mesh vertices and joints.

To overcome these and other challenges, the present disclosure provides techniques for automatically computing an LBS rig using fewer matrix multiplications than some techniques. Most mesh vertices do not change positions from neutral pose to another pose (e.g., the mesh vertices at the top and back of the head). Thus, the present SSDR technique determines joint transforms and skinning weights using only vertex-joint sets in which a vertex i is influenced by joint j. In this way, the number of time and computational resources used to determine the LBS rig may be significantly reduced, as compared to other techniques.

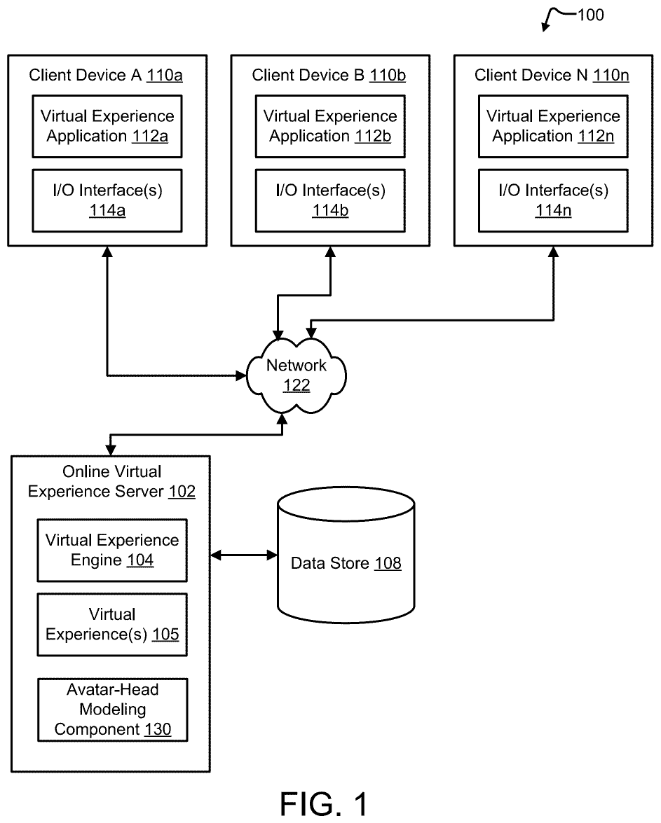

### FIG. 1: System Architecture

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, a client device 110 (or multiple client devices), and a third-party server 118, all connected via a network 122.

The online virtual experience server 102 can include, among other things, a virtual experience engine 104, one or more virtual experiences 105, and an avatar-head modeling component 130. The online virtual experience server 102 may be configured to provide virtual experiences 105 to one or more client devices 110, and to provide automatic generation of avatar heads via the avatar-head modeling component 130, in some implementations.

Data store 108 is shown coupled to online virtual experience server 102 but in some implementations, can also be provided as part of the online virtual experience server 102. The data store may, in some implementations, be configured to store advertising data, user data, engagement data, avatar head data, and/or other contextual data in association with the avatar-head modeling component 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences, which may include virtual user engagement portals as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 1002.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination of a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the online virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for two-dimensional (2D), three-dimensional (3D), virtual reality (VR), or augmented reality (AR) graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. During user interaction within a virtual experience or another GUI of the network environment 100, a user may create an avatar head that includes different head parts (e.g., head shapes, eyes, noses, mouths, chins, lips, cheeks, jawlines, brow lines, hair lines, ears, etc.) from different libraries. The avatar-head modeling component 130 may take as input a mesh associated with a desired avatar head.

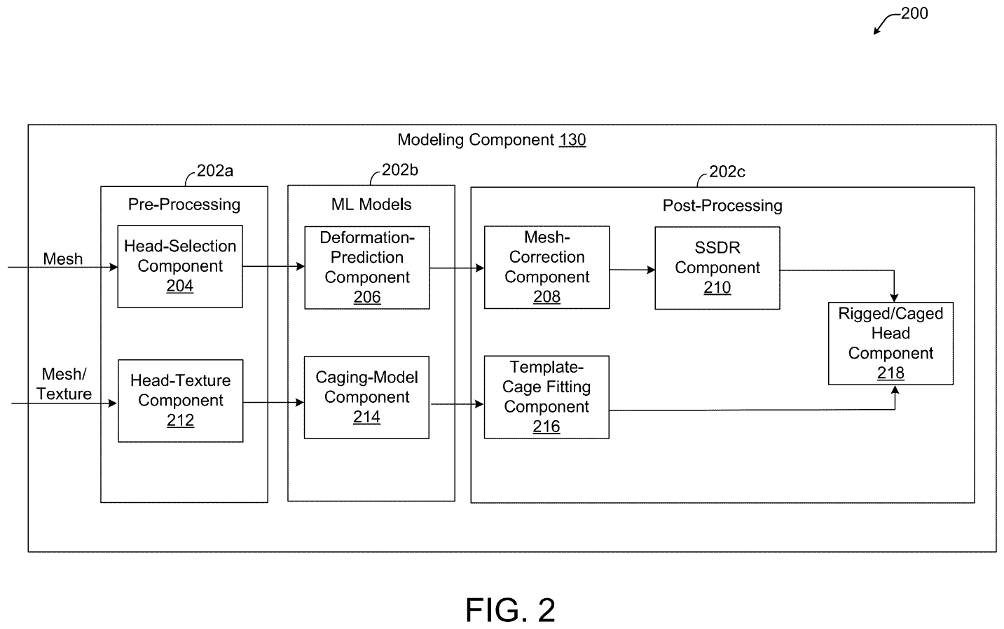

Hereinafter, a more detailed discussion of the avatar-head modeling component 130 is presented with reference to FIGS. 2-6.

### FIG. 2: Avatar-Head Modeling Component

FIG. 2 is a detailed block diagram 200 of the avatar-head modeling component 130 of FIG. 1, in accordance with some implementations. The avatar-head modeling component 130 may include a pre-processing module 202a, a machine-learning (ML) model module 202b, and a post-processing module 202c. The pre-processing module 202a may include a head-selection component 204 and a head-texture component 212. The ML model module 202b may include a deformation-prediction component 206 and a caging-model component 214. The post-processing module 202c may include a mesh-correction component 208, an SSDR component 210, a template-cage fitting component 216, and a rigged/caged head component 218.

The avatar-head modeling component 130 may be arranged with a skinning-computational path and a caging-computational path. The skinning-computational path may include one or more of, e.g., the head-selection component 204, the deformation-prediction component 206, the mesh-correction component 208, and the SSDR component 210. The caging-computational path may include one or more of, e.g., the head-texture component 212, the caging-model component 214, and the template-cage fitting component 216. The rigged/caged head component 218 may be considered part of the skinning-computational path and the caging-computational path or separate from both. The operations performed by each component of the skinning-computational path and the caging-computational path are now described in detail.

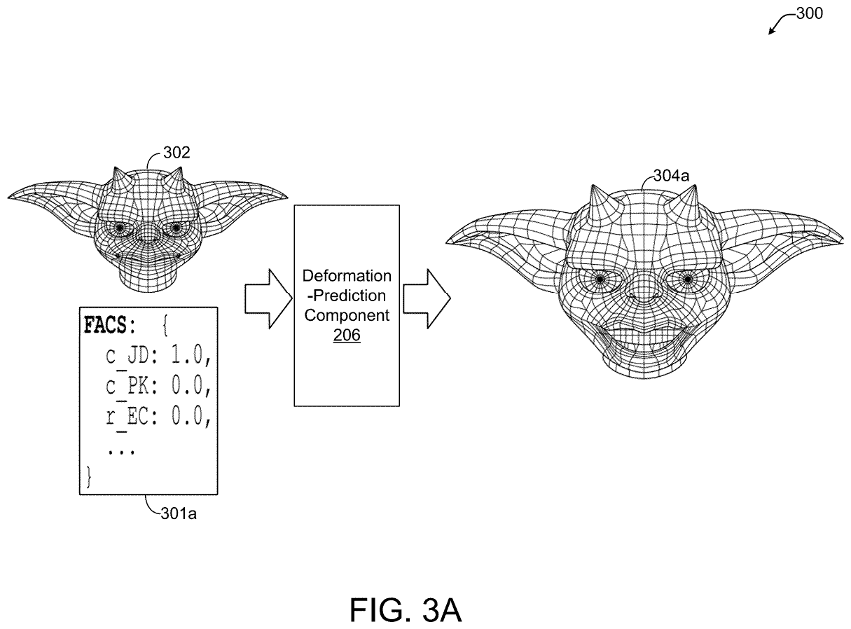

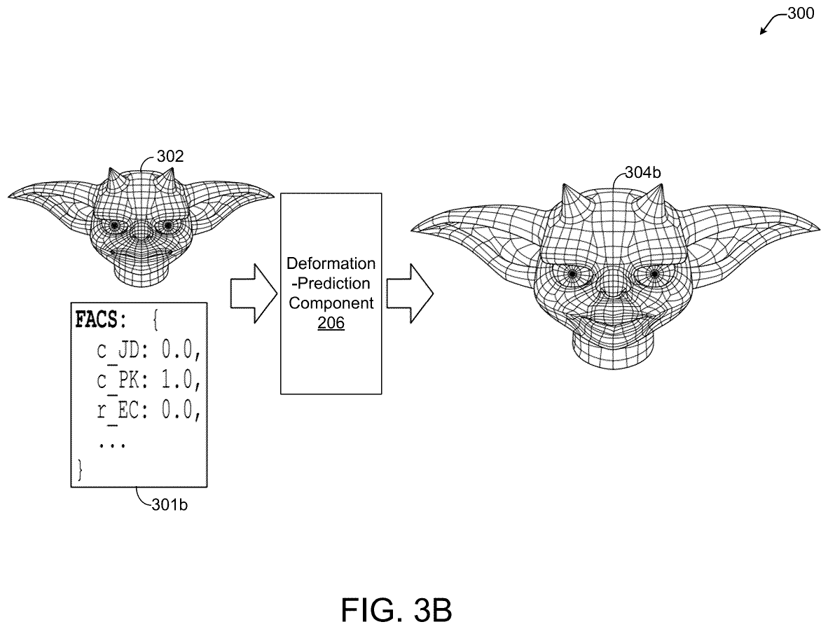

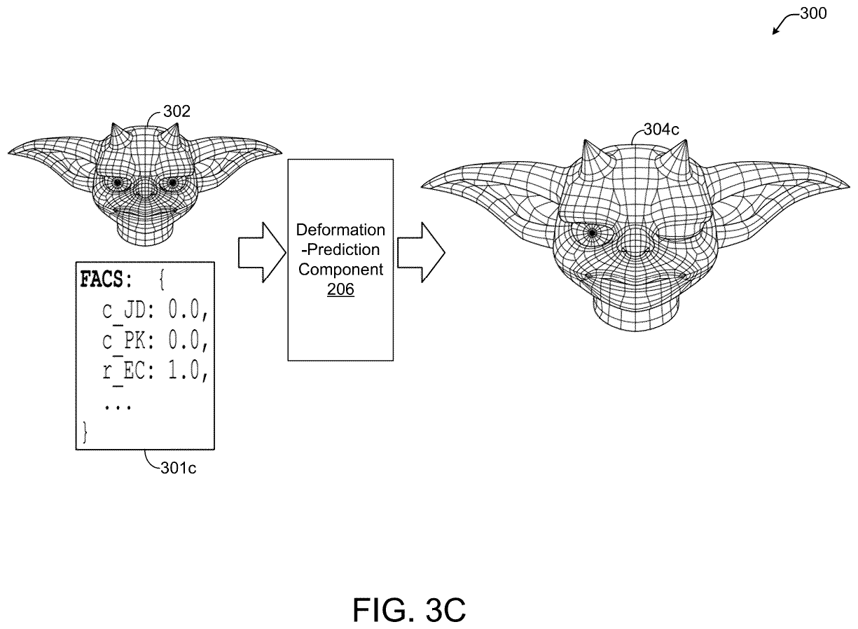

To begin the skinning computation, mesh information associated with an avatar head in neutral pose may be received by the head-selection component 204. In some implementations, the mesh information may include 3D vertex positions for the entire body (or portions thereof, including the avatar head) of the avatar in a neutral pose and corresponding mesh faces, each defined by three or more vertices. The mesh information may be segmented such that vertices associated with different body parts are indicated. Using the indication of body-part segmentation, the head-selection component 204 may identify the mesh portions associated with the avatar head (e.g., the avatar head, with or without an avatar neck). Once identified, the head-selection component 204 may provide the mesh information associated with the avatar head (or head and neck) to the deformation-prediction component 206. Additional details of the deformation-prediction component 206 are described in connection with FIGS. 3A-3C.

### FIGS. 3A-3C: Deformation-Prediction Model for an Avatar Head

FIGS. 3A-3C are schematics of an example visualization of a deformation-prediction model 300 for an avatar head, in accordance with some implementations. The deformation-prediction model 300 depicted in FIGS. 3A-3C may be implemented by the deformation-prediction component 206.

The deformation-prediction component 206 may receive mesh information 302 associated with the avatar head in neutral pose and facial action coding system (FACS) vectors 301a.

The mesh information 302 may include 3D vertices positions and the corresponding faces formed by groups of vertices (e.g., three or more vertices). The mesh information 302 may define the external features/geometry (e.g., eyes, nose, lips, chin, jawline, ears, forehead, etc.) and (optionally) internal features/geometry (e.g., teeth, tongue, gums, etc.) of the avatar head in the neutral pose. Each of the FACS vectors 301 (different examples of FACS vectors 301a, 301b, and 301c are shown in FIGS. 3A-3C respectively) encodes FACS values associated with a respective static pose for prediction.

The deformation-prediction component 206 analyzes the mesh of the avatar head in the neutral pose based on the mesh information 302. The deformation-prediction component 206 deforms the mesh based on a FACS vector to predict a set of mesh deformations associated with the static pose indicated by the FACS vector. The deformation-prediction component 206 may deform the mesh by updating the location of a vertex to a new location associated with a static pose encoded by the FACS vector.

For example, referring to FIG. 3A, the deformation-prediction component 206 receives a FACS vector 301a for a “jaw-drop” pose. As shown, the FACS vector 301a encodes a FACS value of 1.0 for the jaw-drop pose (c_JD), and FACS values of 0.0 for all other poses. Here, the deformation-prediction component 206 may identify a set of vertices associated with the jaw. This set of vertices may include vertices of the lips, jaw, teeth, tongue, etc. Then, the deformation-prediction component 206 may predict per-vertex displacement for each vertex in the set of vertices associated with the jaw.

In another example, referring to FIG. 3B, the deformation-prediction component 206 receives a FACS vector 301b for a “pucker” pose. As shown, the FACS vector 301b encodes a FACS value of 1.0 for the pucker pose (c_PK), and FACS values of 0.0 for all other poses. Here, the deformation-prediction component 206 may identify a set of vertices associated with the mouth. This set of vertices may include vertices of the lips, chin, cheeks, jaw, etc. Then, the deformation-prediction component 206 may predict per-vertex displacement for each vertex in the set of vertices associated with the mouth.

For instance, referring to FIG. 3C, the deformation-prediction component 206 receives a FACS vector 301c for an “eye-closed” pose. As shown, the FACS vector 301c encodes a FACS value of 1.0 for the eye-closed pose (c_EC), and FACS values of 0.0 for all other poses. Here, the deformation-prediction component 206 may identify a set of vertices associated with the left-eye. This set of vertices may include vertices of the eye lips, brow, upper cheek, etc. Then, the deformation-prediction component 206 may predict per-vertex displacement for each vertex in the set of vertices associated with the mouth.

Referring to FIGS. 3A-3C, in some implementations, the per-vertex displacements for each of the plurality of poses may be predicted using the conditional diffusion network, as described below.

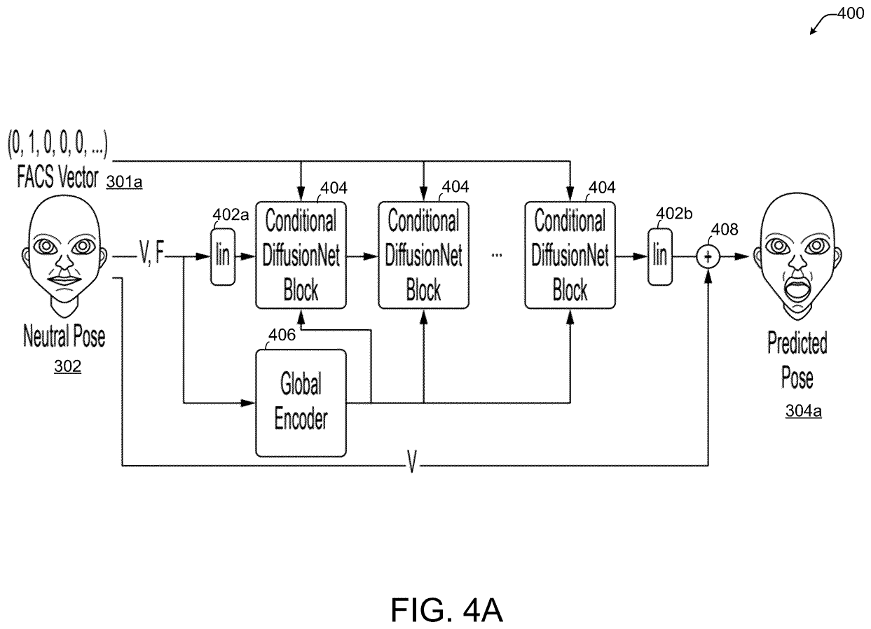

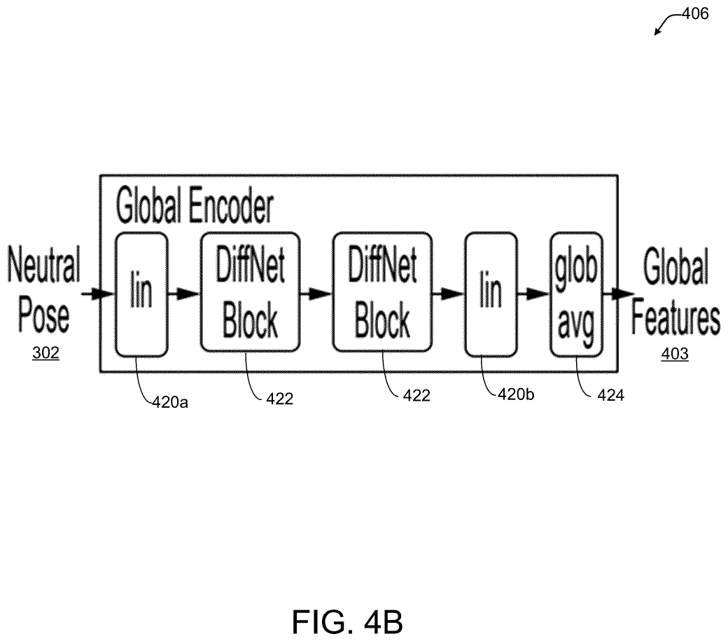

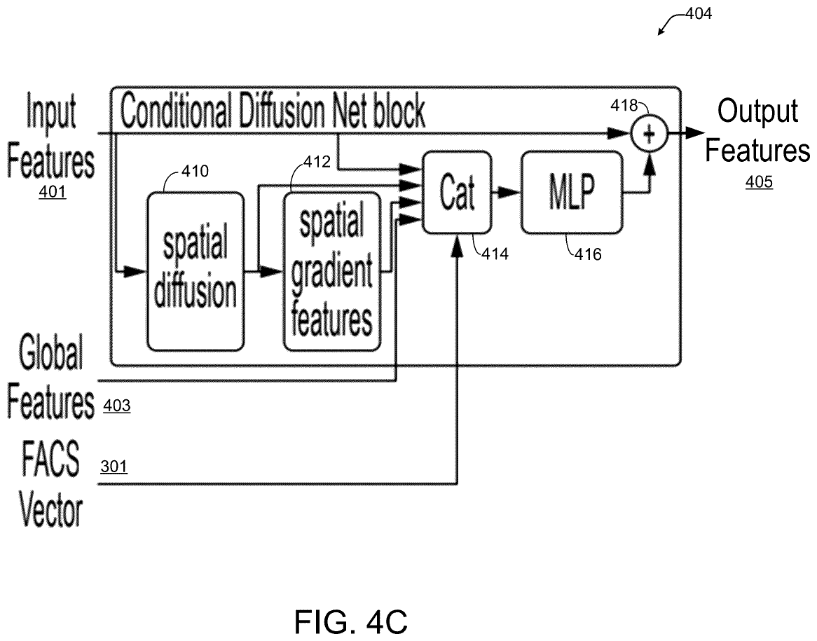

### FIGS. 4A-4C: Conditional Diffusion Network

FIG. 4A is a block diagram of a conditional diffusion network 400, in accordance with some implementations.

Referring to FIG. 4A, the conditional diffusion network 400 may include a first linear block 402a, a plurality of conditional diffusion network blocks 404 arranged in sequence, a global encoder 406, a second linear block 402b, and a combine function 408.

Mesh information 302, which indicates the 3D vertices positions (V) and corresponding mesh faces (F) of the avatar head in neutral pose, is/are input to the first linear block 402a and the global encoder 406. The first linear block 402a may perform a first matrix multiplication using a kernel and the mesh information 302. The first linear block 402a may apply a kernel to convert the size of the mesh information 302 to an input dimension for the plurality of conditional diffusion network blocks 404. A first set of features generated by the first matrix multiplication may be input as input features 401 (see FIG. 4C) into the first of the plurality of conditional diffusion network blocks 404.

Still referring to FIG. 4A, the global encoder 406 may analyze the mesh based on the mesh information 302 and provide global information to the conditional diffusion network blocks 404 to aid the deformation prediction. Additional details of the global encoder 406 are now described below with reference to FIG. 4B.

FIG. 4B is a block diagram of a global encoder 406 of the conditional diffusion network 400 of FIG. 4A, in accordance with some implementations.

Referring to FIG. 4B, the global encoder 406 may include a first linear block 420a, a plurality of diffusion network blocks 422 arranged in sequence, a second linear block 420b, and a global-averaging component 424. The first linear block 420a may perform a first matrix multiplication using a kernel and the mesh information 302. The first linear block 420a may apply the kernel to convert the size of the mesh information 302 to an input dimension for the plurality of diffusion network blocks 422. A first set of output features generated by the first matrix multiplication may be input into the first of the plurality of diffusion network blocks 422.

Each diffusion network block 422 diffuses every feature for a learned time scale, forms spatial gradient features, and applies a spatially shared pointwise multi-layer perceptron (MLP) at each vertex in the mesh. To that end, each of the diffusion network blocks 422 may include a spatial diffusion component (not shown), a spatial gradient features component (not shown), a concatenator (not shown), an MLP component (not shown), and an adder (not shown). The spatial diffusion component may perform learned diffusion for spatial communication across the entire mesh based on the features input by the first linear block 420a. The learned diffusion information may be input into the spatial gradient features component, which may identify spatial gradient features to model directional filters. The concatenator may concatenate the mesh information 302, the learned diffusion information, and the spatial gradient features. The concatenated information may be input to the MLP component. The MLP component may apply an MLP independently to each vertex to represent pointwise functions. Then, the adder may sum the pointwise functions output by the MLP component and the mesh information 302.

Still referring to FIG. 4B, the second linear block 420b may perform a second matrix multiplication using a kernel and the output from the last diffusion network block 422. The second linear block 420b may apply the kernel to convert the output from the last diffusion network block 422 to an output dimension for the global-averaging component 424. Thus, the kernel applied by the second linear block 402b may be different than the kernel applied by the first linear block 402a. In some implementations, this dimension may be the same as the size of the mesh information 302 or different. A second set of output features generated by the second matrix multiplication may be input into the global-averaging component 424. The global-averaging component 424 may perform global averaging of the second set of output features to obtain global features 403. The global features 403 may be input into each of the plurality of conditional diffusion network blocks 404, as shown in FIG. 4C.

FIG. 4C is a block diagram of a conditional diffusion network block 404 of the conditional diffusion network 400 of FIG. 4A, in accordance with some implementations.

Referring to FIG. 4C, each of the conditional diffusion network blocks 404 may include a spatial diffusion component 410, a spatial gradient features component 412, a concatenator 414, at least one MLP component 416, and a combine function 418. Different from the diffusion network block 422 described above in connection with the global encoder 406, the conditional diffusion network blocks 404 are conditioned based on variables, e.g., the FACS vector(s) 301 and the global features 403. The inputs to each conditional diffusion network block 404 may include the input features 401 (either from first linear block 402a or from a previous conditional diffusion network block 404 from the sequence of blocks 404), the FACS vector 301, and the global features 403 generated by the global encoder 406.

Still referring to FIG. 4C, the spatial diffusion component 410 may perform learned diffusion for spatial communication across the entire mesh based on the input features 401. The learned diffusion information may be input into the spatial gradient features component 412, which may identify spatial gradient features to model directional filters. The concatenator 414 may concatenate the FACS vector 301, the input features 401, the global features 403, the learned diffusion information, and the spatial gradient features. The concatenated information may be input to the MLP component 416. The MLP component 416 may apply an MLP independently to each vertex to represent pointwise functions. Then, the combine function 418 may modify the input features 401 and the pointwise functions output by the MLP component so that its output features 405 can be used to obtain the output pose. The output features 405 may be input into the next conditional diffusion network block 404 in the series or into the second linear block 402b, shown in FIG. 4A.

Referring again to FIG. 4A, the second linear block 402b may perform a second matrix multiplication using a kernel and the output features 405 from the last of the conditional diffusion network blocks 404. The second linear block 402b may apply a kernel to convert the size of the output features 405 back to the size of the mesh information 302. The combine function 408 may modify the 3D vertex positions from the mesh information 302 using the output features from the second linear block 402b to generate the set of mesh deformations 304 for the static pose associated with the respective FACS vector 301 (e.g., 301a->304a, 301b->304b, 301c->304c).

The operations described above with reference to FIGS. 4A-4C may be respectively performed for any pose of a plurality of different poses to generate a final set of mesh deformations that may be used for skinning, which is used for animating the avatar's head.

Referring back to FIG. 2, the plurality of mesh deformations (304) predicted by the deformation-prediction component 206 may be input into the mesh-correction component 208. However, at this stage, it is possible that the internal geometry (e.g., teeth, tongue, inner mouth bag, etc.) may crash through (intersect) the face surface of the avatar head based on the set of mesh deformations. Mesh-correction component 208 may detect collisions between the head surface and internal geometries and may push these internal parts to be behind the external surface of the avatar face.

Mesh-correction component 208 may identify the external surface and the internal features of the avatar head in the neutral pose based on the mesh information. The mesh faces associated with the external surface of the head mesh in neutral pose may first be identified. For instance, the mesh-correction component 208 may identify a first plurality of depth values associated with the external surface of the avatar head for one of the poses. The mesh-correction component 208 may also identify a second plurality of depth values associated with the internal features of the avatar head for that pose.

The mesh-correction component 208 may perform a rasterization operation directed at the front of the avatar head for the pose to identify internal features that have a larger Z-coordinate value (e.g., the second plurality of depth values) than the Z-coordinate values (e.g., first plurality of depth values) of corresponding external features. A collision is detected when the Z-coordinate value of one of the internal features is greater than or equal to the Z-coordinate value of a corresponding one of the external features. When a collision is detected, the mesh-correction component 208 adjusts the Z-coordinate values of the internal features for that pose to be less than the corresponding Z-coordinate values of the external features. The mesh-correction component 208 may perform these operations for each of the predicted poses. In some implementations, when no collisions are detected, no adjustments are performed.

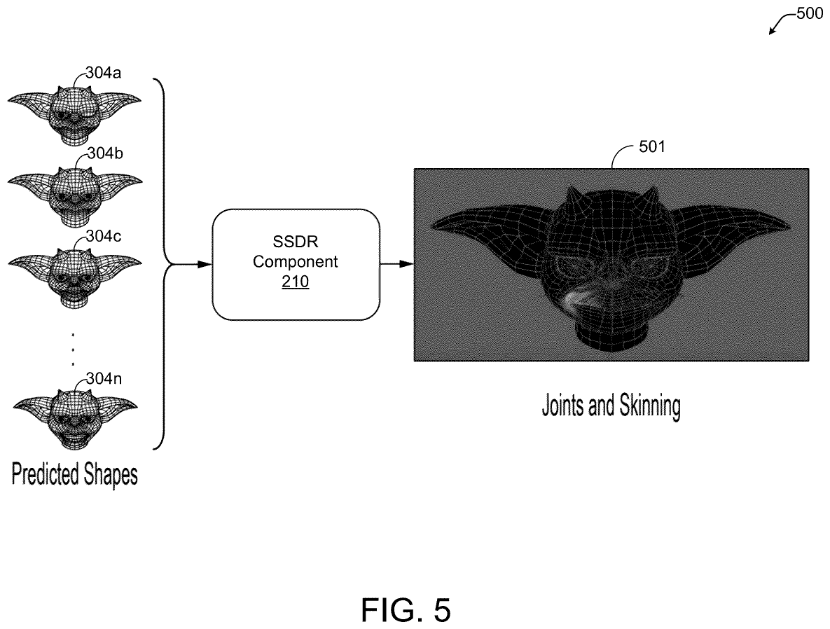

After the adjustment, the set of mesh deformations with mesh corrections may be provided to the SSDR component 210. Additional details of the SSDR component 210 and its associated operations are described below in connection with FIG. 5.

FIG. 5: SSDR Model for an Avatar Head

FIG. 5 is a schematic of an example illustration of an SSDR model 500 for an avatar head, in accordance with some implementations. The SSDR model 500 may be implemented by the SSDR component 210.

To convert the set of mesh deformations 304 to a linear blend skinning (LBS) rig 501 that is suitable for animation, the SSDR component 210 may perform an SSDR optimization to compute the final joints and skinning for the avatar head. The optimization scheme is a coordinate descent to find the single global skinning weights and per-pose joint transforms that best fit each predicted FACS pose.

For instance, the iterations may proceed in the following way. In a first operation, while holding skinning weights constant, the SSDR component 210 identifies rigid joint transforms for every pose (e.g., 304a, 304b, 304c, . . . , 304n, etc.). Then, in a second operation, while holding all joint transforms for every pose constant (e.g., 304a, 304b, 304c, . . . , 304n, etc.), the SSDR component 210 optimizes the skinning weights. In so doing, the SSDR component 210 may compute the LBS rig 501 based on the plurality of mesh deformations 304.

The accuracy of the LBS rig 501 computed by the SSDR component 210 may be dependent on the choice of initial skinning weights. To that end, the SSDR component 210 may compute a spectral clustering of vertices of the mesh into clusters where vertices in each cluster tend to move together for the set of mesh deformations 304 for the respective FACS poses. In some implementations, a machine learning model that predicts initial skinning weights for the SSDR component 210 may be used.

Additional details of the determination of the initial skinning weights and the iterations to determine the rigid joint transforms (rotational transform and translational transform) by the SSDR component 210 will now be described.

To begin, the SSDR component 210 may determine a set of vertex-joint clusters. For a given target number of joints J (typically set to J=30), the idea is to cluster the vertices of the mesh into J clusters, so that the cluster of vertices associated with joint j generally move together across the pose p.

To begin, the SSDR component 210 receives mesh information indicating the N vertex positions of the mesh in neutral pose: {vᵢ⁽⁰⁾}ᵢ₌₁^{N}. For each pose p=1, . . . , P, the SSDR component 210 receives the mesh deformations 304, which indicates finals vertex positions as {vᵢ^{(p)}}ᵢ₌₁^{N}.

To determine the set of vertex-joint pairs in which joint j has influence over vertex I for each of pose p=1, . . . , P, the SSDR component 210 may compute a feature vector feature[i] with a dimension of P for each vector i. For instance, the SSDR component 210 may compute the feature vector according to equation (1).

$$feature [ i ] = {[ ‖ {v}_{i}^{( 1 )} - {v}_{i}^{( 0 )} ‖ , … , ‖ {v}_{i}^{( p )} - {v}_{i}^{( 0 )} ‖ , … , ‖ {v}_{i}^{( P )} - {v}_{i}^{( 0 )} ‖ ]}^{T} , \qquad ( 1 )$$

where T is a transform.

Using the information computed by the feature vector for each vertex i, the SSDR component 210 may perform spectral clustering of the vertices to determine the set of vertex-joint pairs for joint j. For instance, when the final vertex position vᵢ^{(p)} minus the initial vertex position vᵢ⁽⁰⁾ for joint j is non-zero, the SSDR component 210 may determine vertex i is influenced by joint j, and thus, forms a vertex-joint cluster. Otherwise, when the final vertex position vᵢ^{(p)} minus the initial vertex position vᵢ⁽⁰⁾ for joint j is zero, the SSDR component 210 may determine vertex i is not influenced by joint j, and thus, is excluded from the set of vertex-joint clusters for joint j. The SSDR component 210 may set the initial skinning weight wᵢⱼ (which encodes the influence of joint j on vertex i) to 1 if vertex i is in the j'th cluster; otherwise, the initial skinning weight wᵢⱼ is set to 0.

Once the set of vertex-joint pairs are determined, the SSDR component 210 may perform vectorized matrix operations to determine an LBS rig that includes joint transforms and final skinning weights. The final position of vertex i, denoted by \hat{v}ᵢ, for an LBS rig when each joint j=1, . . . , J undergoes a rigid transformation, Rⱼ (3×3 rotation) and Tⱼ (3×1 translation), may be described according to equation (2).

$${\hat{v}}_{i} = {\sum }_{j = 1}^{J} {w}_{ij} ( {R}_{j} {v}_{i}^{( 0 )} + {T}_{j} ) . \qquad ( 2 )$$

For the set of all poses P, the SSDR component 210 may determine optimized skinning wᵢⱼ and joint transforms Rⱼ^{(p)}, Tⱼ^{(p)} for every joint j and pose p to match all of the final pose vertex positions vᵢ^{(p)}, e.g., by solving for equation (3).

$${min}_{{w}_{ij} , {R}_{j}^{( p )} , {T}_{j}^{( p )}} {\sum }_{p = 1}^{P} {\sum }_{i = 1}^{N} {‖ {v}_{i}^{( p )} - {\sum }_{j = 1}^{J} {w}_{ij} ( {R}_{j}^{( p )} {v}_{i}^{( 0 )} + {T}_{j}^{( p )} ) ‖}^{2} . \qquad ( 3 )$$

The SSDR component 210 may implement a coordinate descent approach to solve the above optimization problem of equation (3). The coordinate descent approach may iterate between solving for the joint transform and the skinning weights. To solve for the joint transform, the SSDR component 210 may hold the skinning weights wᵢⱼ constant while solving for each joint j for each pose p. Then, to solve for the skinning weights, the SSDR component 210 may hold all joint transforms Rⱼ^{(p)}, Tⱼ₍ₚ₎ for every joint j=1, . . . , J and every poses p=1, . . . , P constant while solving for the skinning weights wᵢⱼ.

For instance, to solve for the joint transform for each joint j and for each pose p=1, . . . , P and for each joint k=1, . . . , J, the SSDR component 210 may hold all joint transforms constant other than the k^{th} joint while solving for Rₖ^{(p)}, Tₖ^{(p)}. Solving for the joint transform for each joint j and pose p imparts the greatest amount of computational-complexity to LBS-rid determination. To reduce this computational complexity, the SSDR component 210 may solve for a single joint transform for joint k and for a single pose p, while holding everything else constant. This reduces the computational complexity in the following way.

For instance, removing the k^{th} transform from the summation of equation (3), equation (3) can be rewritten as equation (4).

$${min}_{{R}_{k}^{( p )} , {T}_{k}^{( p )}} {‖ {v}_{i}^{( p )} - {\sum }_{j = 1 , j \neq k}^{J} {w}_{ij} ( {R}_{j}^{( p )} {v}_{i}^{( 0 )} + {T}_{j}^{( p )} ) - {w}_{ik} ( {R}_{k}^{( p )} {v}_{i}^{( 0 )} + {T}_{k}^{( p )} ) ‖}^{2} . \qquad ( 4 )$$

Equation (4) can be written as equation (5), shown below.

$${min}_{{R}_{k}^{( p )} , {T}_{k}^{( p )}} {‖ {α}_{i , k}^{( p )} - {w}_{ik} ( {R}_{k}^{( p )} {v}_{i}^{( 0 )} + {T}_{k}^{( p )} ) ‖}^{2} , \qquad ( 5 )$$

$$where$$

$${α}_{i , k}^{( p )} = {v}_{i}^{( p )} - {\sum }_{j = 1 , j \neq k}^{J} {w}_{ij} ( {R}_{j}^{( p )} {v}_{i}^{( 0 )} + {T}_{j}^{( p )} ) . \qquad ( 6 )$$

Equation (5) is equivalent to equation (7), as shown below.

$${min}_{{R}_{k}^{( p )} , {T}_{k}^{( p )}} {w}_{ik}^{2} {‖ ( {R}_{k}^{( p )} {v}_{i}^{( 0 )} + {T}_{k}^{( p )} ) - \frac{{α}_{i , k}^{( p )}}{{w}_{ik}} ‖}^{2} . \qquad ( 7 )$$

The SSDR component 210 can solve for Rₖ^{(p)}, Tₖ^{(p)} using a single variable decomposition (SVD) of equation (7) once α_{i,k}^{(p)} is determined.

Computing α_{i,k}^{(p)} in a straightforward manner for every joint k=1, . . . , J requires an undesirable amount of computational resources. However, because the number of skinning weights wᵢⱼ that are greater than 0 are relatively few (as compared with the total number of mesh vertices), the SSDR component 210 does not need to transform every neutral vertex vᵢ⁽⁰⁾ by every joint j. Instead, the SSDR component 210 can limit computing Rⱼ^{(p)}vᵢ⁽⁰⁾+Tⱼ^{(p)} for only vertex-joint pairs where wᵢⱼ>0. To reduce the complexity of computing α_{i,k}^{(p)}, the SSDR component 210 may compute LBS coefficients β_{i,j}^{(p)} and γᵢ^{(p)}, as described below.

For instance, β_{i,j}^{(p)} may be defined according to equation (8).

$${β}_{i , j}^{( p )} = {w}_{ij} ( {R}_{j}^{( p )} {v}_{i}^{( 0 )} + {T}_{j}^{( p )} ) . \qquad ( 8 )$$

The SSDR component 210 may compute each of these β_{i,j}^{(p)} only for the vertex-joint pairs where wᵢⱼ>0. Thus, α_{i,k}^{(p)} can be written as equation (9), shown below.

$${α}_{i , k}^{( p )} = {v}_{i}^{( p )} - {\sum }_{j : {w}_{ij} > 0 , j \neq k} {β}_{i , j}^{( p )} . \qquad ( 9 )$$

Equation (9) is equivalent to equation (10), shown below.

$${α}_{i , k}^{( p )} = {v}_{i}^{( p )} - {\sum }_{j : {w}_{ij} > 0} {β}_{i , j}^{( p )} + {β}_{i , k}^{( p )} . \qquad ( 10 )$$

Because the summand in equation (10) includes a large number of repeated summations as k=1, . . . , J, the computational complexity of determining α_{i,k}^{(p)} can be further reduced by precomputing the sum part as γᵢ^{(p)}, according to equation (11).

$${γ}_{i}^{( p )} = {\sum }_{j : {w}_{ij} > 0} {β}_{i , j}^{( p )} . \qquad ( 11 )$$

Thus, the SSDR component 210 may determine α_{i,k}^{(p)} according to equation (12).

$${α}_{i , k}^{( p )} = {v}_{i}^{( p )} - {γ}_{i}^{( p )} + {β}_{i , k}^{( p )} . \qquad ( 12 )$$

Moreover, the SSDR component 2120 may determine α_{i,k}^{(p)} for every vertex i=1, . . . , N and joint k=1, . . . , J in parallel. Once α_{i,k}^{(p)} has been computed, the SSDR component 210 may input this value into equation (7) and solve for Rₖ^{(p)}, Tₖ^{(p)} using an SVD.

The SSDR component 210 may use a learning rate A to update the transforms Rₖ^{(p)}, Tₖ^{(p)} for every joint, which will be the values for the next iteration. For instance, the transforms may be updated according to equations (13) and (14).

$${R}_{k}^{( p )} := ( 1 - λ ) {R}_{k}^{( p )} + λ {\hat{R}}_{k}^{( p )} , and \qquad ( 13 )$$

$${T}_{k}^{( p )} := ( 1 - λ ) {T}_{k}^{( p )} + λ {\hat{T}}_{k}^{( p )} . \qquad ( 14 )$$

Then, the SSDR component 210 may solve for the final skinning weights wᵢⱼ while holding the joint transforms constant Rⱼ^{(p)}, Tⱼ^{(p)} for every joint j=1, . . . , J and poses p=1, . . . , P, constant.

In this way, the SSDR component 210 determines and LBS rig 501 for the avatar head in less time and using fewer computational resources, as compared to some techniques. The techniques described above in connection with the SSDR component 210 may reduce the number of matrix multiplications used to determine the joint transforms by up to 85%, as compared to some techniques.

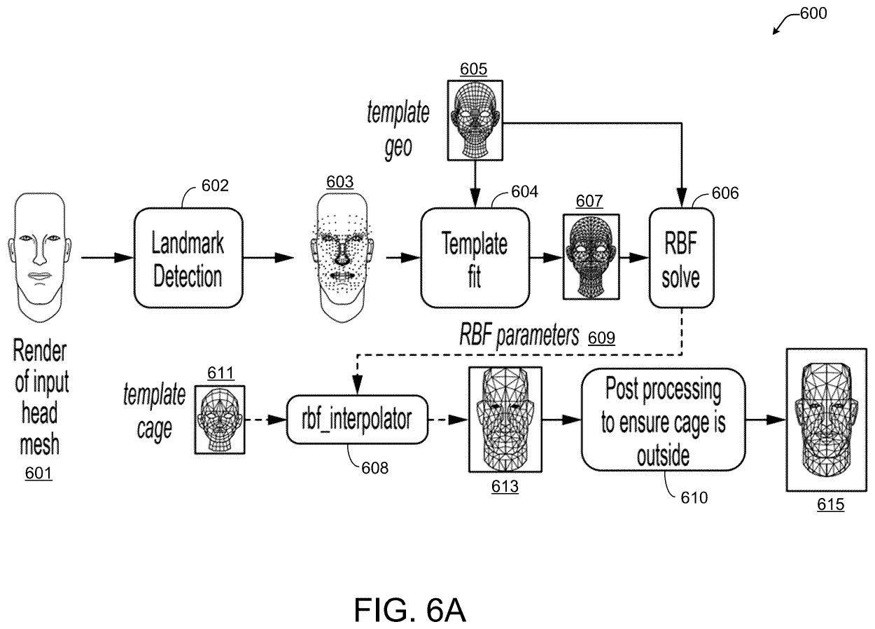

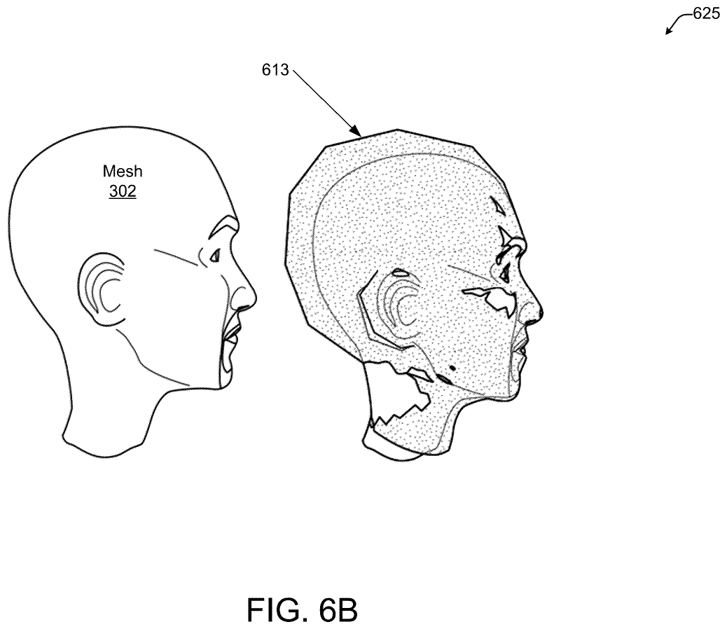

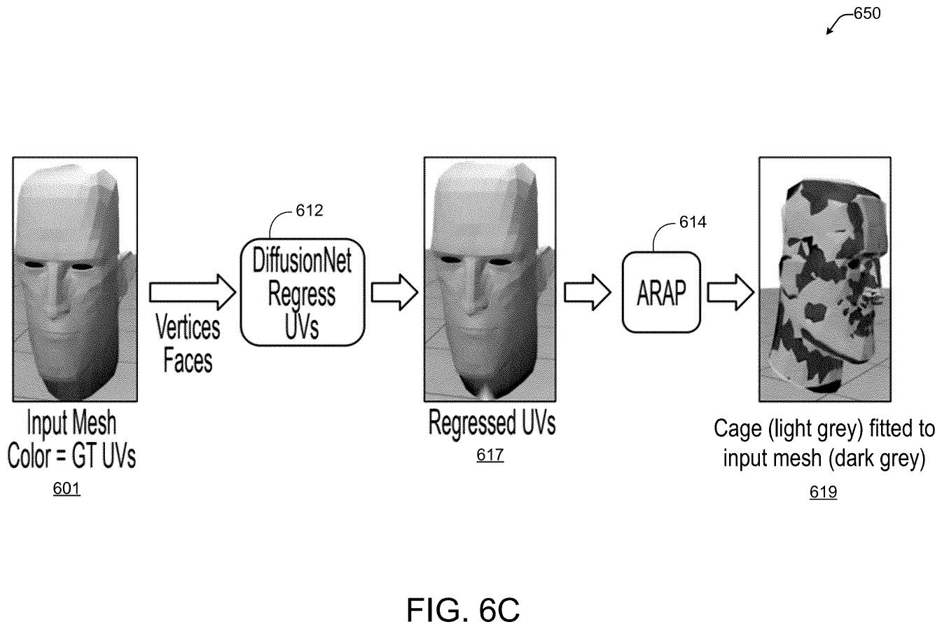

Referring again to FIG. 2, details of the caging-computational path are now described. In some implementations, the caging-computational path may include a landmark-detection model implemented by caging-model component 214. When the landmark-detection model is used, pre-processing module 202a may include a head-texture component 212. The head-texture component 212 may be configured to generate a textured mesh based on the mesh information and texture information. A textured mesh may include color and/or other attributes information assigned to corresponding vertices and/or faces of the mesh. For instance, the eye color of the avatar may be assigned to the vertices and/or faces associated with the eyes, etc. The textured-mesh information may be input into caging-model component 214, which uses the textured mesh for landmark detection. Additional details of the landmark-detection model are now described in connection with FIGS. 6A and 6B.

FIGS. 6A and 6B: Caging-Computational Path with Landmark Detection

FIG. 6A is a schematic of an example illustration of the caging-computational path 600 that uses landmark detection, in accordance with some implementations.

Referring to FIG. 6A, an example of the caging-computational path that uses landmark detection is shown. In this implementation, the caging-computational path may include a landmark-detection model 602, a template-fit model 604, a radial basis function (RBF) solver 606, an RBF interpolator 608, and a post-processing component 610. With reference to FIG. 2, the caging-model component 214 may be configured to implement operations associated with one or more of, e.g., the landmark-detection model 602, the template-fit model 604, and the RBF solver 606; and the template-cage fitting component 216 may be configured to implement operations associated with one or more of, e.g., the RBF interpolator 608 and the post-processing component 610.

A textured mesh 601 of the avatar head in neutral pose may be provided as input to the landmark-detection model 602. The landmark-detection model 602 may detect a plurality of two-dimensional (2D) landmarks 603 that correspond to the different facial features of the avatar head. For instance, various points on the eyes, nose, lips, brows, etc. may be detected based on the vertices and/or corresponding textures of the textured mesh 601. The 2D landmarks 603 may be provided as input to the template-fit model 604, along with a template geometry 605 of a 3D template avatar head.

The template-fit model 604 may identify 3D landmarks associated with the textured mesh 601 by raycasting the 2D landmarks 603 onto the template geometry 605. The template-fit model 604 may deform the 3D template geometry 605 so that after the deforming, the template landmarks of a deformed geometry 607 align with the 3D landmarks of the input geometry.

For instance, the template geometry 605 and the deformed geometry 607 may have a one-to-one correspondence between vertices such that morphing the vertices of the template geometry 605 by the template-fit model 604 to match the shape of the 3D landmarks results in the deformed geometry 607. Based on these parameters, the RBF solver 606 creates a function of x, y, and z coordinates that outputs another x, y, and z coordinates. In other words, the RBF solver 606 constrains a deformation field (e.g., a non-linear function) so that points in the mesh other than the 3D landmarks can be interpolated to the appropriate location (e.g., points on the forehead, the checks, etc.). This deformation field is output as RBF parameters 609 to the RBF interpolator 608.

The RBF parameters 609 and a template cage 611 may be provided as input to the RBF interpolator 608. The RBF interpolator 608 may apply the RBF parameters 609 to the template cage 611 to identify deformation vectors associated with vertices of the template cage 611. The RBF interpolator 608 may further identify a set of vertex positions for an initial cage 613 based on the deformation vectors. The RBF interpolator 608 may generate the initial cage 613 based on the set of vertex positions identified based on the deformation vectors. The initial cage 613 may be provided as input to the post-processing component 610.

The post-processing component 610 may adjust the size of the initial cage 613 to fit the textured mesh 601, as described below with reference to FIG. 6B.

FIG. 6B is a schematic of an example illustration 625 of a cage fitted to the head mesh by the template-cage fitting component 216 using landmark detection, in accordance with some implementations.

Referring to FIG. 6B, the initial cage 613 as it fits over the mesh is shown. The reason the cage does not fit the back of the head with a high degree of accuracy is that there are no landmarks on the back of the head that can be identified by the landmark-detection model 602. Thus, the post-processing component 610 may generate a final cage 615 by adjusting a shape of the initial cage 613 based on the textured mesh 601 of the avatar head. In this way, a cage may be automatically generated using landmark detection.

In some implementations, the caging-computational path may include a regression model (e.g., UV-regression model) implemented by caging-model component 214. When the regression model is used, the head-texture component 212 may be omitted from the pre-procession module 202a. This is because a mesh without texture may be used for computing a cage using the regression model. Additional details of the regression model are now described with reference to FIG. 6C.

FIG. 6C: Caging-Computational Path with UV Regression

FIG. 6C is a schematic of an example illustration of the caging-computational path 650 that uses UV regression, in accordance with some implementations.

Referring to FIG. 6C, textured mesh 601 may be input into cage-model component 214 for UV regression. UV regression is the 3D modeling process of projecting a 3D model's surface to a 2D image for texture mapping. The letters “U” and “V” denote the axes of the 2D texture while “X”, “Y”, and “Z” are used to denote the axes of the 3D object in model space.

In this implementation, the cage-model component 214 may include one or more diffusion network blocks 612 configured to regress UV coordinates from the mesh information 621. In this case, the diffusion network block(s) 612 establishes a correspondence with the cage by regressing UV coordinates 617 for the vertices based on the textured mesh 601. The diffusion network block(s) 612 may include the same or similar structure as those described above in connection with FIGS. 4A-4C.

The regressed UV coordinates 617 may be provided as input to the template-cage fitting component 216, which may implement an as-rigid as-possible (ARAP) model 614 to solve for the cage deformation. Using the ARAP model 614, the template-cage fitting component 216 may identify a cage deformation that matches the points on the surface of the cage at the regressed UV coordinates 617 to the corresponding vertices of the textured mesh 601. In some implementations, the template-cage fitting component 216 may perform mean-fitting error operations to determine the distance between the vertices in the mesh and their corresponding points on the cage. In this way, an output cage 619 (light grey) fitted to an input mesh (dark grey) may be automatically generated for an avatar head using UV regression.

Referring again to FIG. 2, rigged/caged head component 218 may receive the LBS rig and the cage from the SSDR component 210 and the template-cage fitting component 216, respectively. Using the LBS rig and the cage, the rigged/caged head component 218 may animate the avatar head. The LBS rig may be used to animate the avatar's face, while the cage may be used to animate the avatar's hair, facial hair, or head/neck clothing (e.g., hat, scarf, etc.).

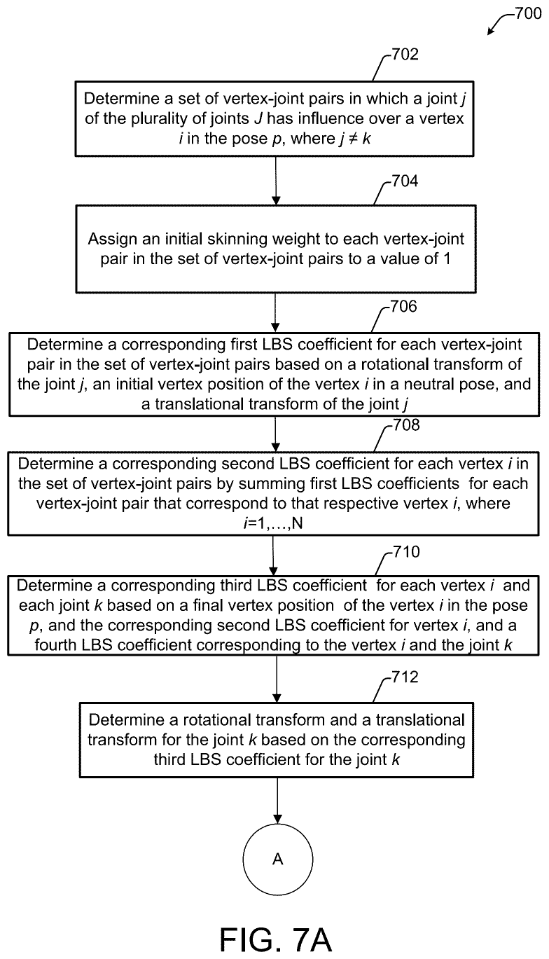

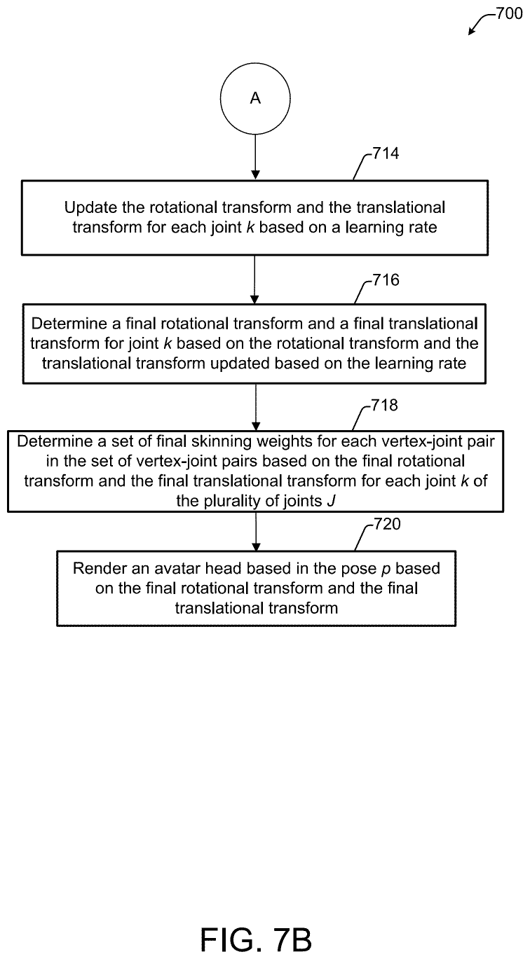

Hereinafter, a more detailed discussion of a method of mesh-deformation prediction is presented with reference to FIGS. 7A and 7B.

### FIGS. 7A and 7B: Example Method(s) of LBS-Rig Generation for an Avatar Head

FIGS. 7A and 7B are a flowchart of an example method 700 of LBS-rig generation for animation, in accordance with some implementations.

In some implementations, method 700 can be implemented, for example, on an online virtual experience server 102 described with reference to FIG. 1. In some implementations, some or all of the method 700 can be implemented on one or more client devices 110 as shown in FIG. 1, on one or more developer devices (not illustrated), or on one or more online virtual experience server 102, and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 700. In some examples, a first device is described as performing blocks of method 700. Some implementations can have one or more blocks of method 700 performed by one or more other devices (e.g., other client devices or server devices) that can send results or data to the first device.

In some implementations, method 700, or portions of the method, can be initiated automatically by a system. In some implementations, the implementing system is a first device. For example, the method (or portions thereof) can be periodically performed, or performed based on one or more particular events or conditions, e.g., upon a user request, upon a change in avatar head dimensions, upon a change in avatar head parts, a predetermined time period having expired since the last performance of method 700 for a particular avatar model or user, and/or one or more other conditions occurring which can be specified in settings read by the methods.

Referring to FIG. 7A, method 700 may begin at block 702. At block 702, a set of vertex-joint pairs may be determined in which a joint j of the plurality of joints J has influence over a vertex i in the pose p, where j #k. For example, referring to FIG. 5, to begin, the SSDR component 210 receives mesh information indicating the N vertex positions of the mesh in neutral pose: {vᵢ⁽⁰⁾}ᵢ₌₁^{N}. For each pose p=1, . . . , P, the SSDR component 210 receives the mesh deformations 304, which indicates finals vertex positions as {vᵢ^{(p)}}ᵢ₌₁^{N}. To determine the set of vertex-joint pairs in which joint j has influence over vertex I for each of pose p=1, . . . , P, the SSDR component 210 may compute a feature vector feature[i] with a dimension of P for each vector i. For instance, the SSDR component 210 may compute the feature vector according to equation (1), shown above. Using the information computed by the feature vector for each vertex i, the SSDR component 210 may perform spectral clustering of the vertices to determine the set of vertex-joint pairs for joint j. For instance, when the final vertex position vᵢ^{(p)} minus the initial vertex position vᵢ⁽⁰⁾ for joint j is non-zero, the SSDR component 210 may determine vertex i is influenced by joint j, and thus, forms a vertex-joint cluster. Otherwise, when the final vertex position vᵢ^{(p)} minus the initial vertex position vᵢ⁽⁰⁾ for joint j is zero, the SSDR component 210 may determine vertex i is not influenced by joint j, and thus, is excluded from the set of vertex-joint clusters for joint j. T

Block 702 may be followed by block 704. At block 704, an initial skinning weight may be assigned to each vertex-joint pair in the set of vertex-joint pairs to a value of 1. For example, referring to FIG. 5, the SSDR component 210 may set the initial skinning weight wᵢⱼ (which encodes the influence of joint j on vertex i) to 1 if vertex i is in the j'th cluster; otherwise, the initial skinning weight wᵢⱼ is set to 0.

Block 704 may be followed by block 706. At block 706, a corresponding first LBS coefficient β_{i,j}^{(p)} may be determined for each vertex-joint pair in the set of vertex-joint pairs based on a rotational transform Rⱼ^{(p)} of the joint j, an initial vertex position vᵢ⁽⁰⁾ of the vertex i in a neutral pose, and a translational transform Tⱼ^{(p)} of the joint j. For example, referring to FIG. 5, a corresponding first LBS coefficient β_{i,j}^{(p)} (see equation (9)) for each vertex-joint pair in the set of vertex-joint pairs based on a rotational transform Rⱼ^{(p)} of the joint j, an initial vertex position vᵢ⁽⁰⁾ of the vertex i in a neutral pose, and a translational transform Tⱼ^{(p)} of the joint j.

Block 706 may be followed by block 708. At block 708, a corresponding second LBS coefficient γi^{(p)} may be determined for each vertex i in the set of vertex-joint pairs by summing first LBS coefficients β_{i,j}^{(p)} for each vertex-joint pair that correspond to that respective vertex i, where i=1, . . . , N. For example, referring to FIG. 5, because the summand in equation (10) includes a large number of repeated summations as k=1, . . . , J, the computational complexity of determining α_{i,k}^{(p)} can be further reduced by precomputing the sum part as γᵢ^{(p)}, according to equation (11)

Block 708 may be followed by block 710. At block 710, a corresponding third LBS coefficient α_{i,k}^{(p)} for each vertex i and each joint k based on a final vertex position vᵢ^{(p)} of the vertex i in the pose p, and the corresponding second LBS coefficient γᵢ^{(p)} for vertex i, and a fourth LBS coefficient β_{i,k}^{(p)} corresponding to the vertex i and the joint k. For example, referring to FIG. 5, the SSDR component 210 may determine α_{i,k}^{(p)} according to equation (12). Moreover, the SSDR component 2120 may determine α_{i,k}^{(p)} for every vertex i=1, . . . , N and joint k=1, . . . , J in parallel.

Block 710 may be followed by block 712. At block 712, a rotational transform Rₖ^{(p)} and a translational transform Tₖ^{(p)} for the joint k based on the corresponding third LBS coefficient α_{i,k}^{(p)} for the joint k. For example, referring to FIG. 5, once α_{i,k}^{(p)} has been computed, the SSDR component 210 may input this value into equation (7) and solve for Rₖ^{(p)}, Tₖ^{(p)} using an SVD.

Referring to FIG. 7B, block 712 may be followed by block 714. At block 714, the rotational transform Rₖ^{(p)} and the translational transform Tₖ^{(p)} may be updated for each joint k based on a learning rate λ. For example, referring to FIG. 5, the SSDR component 210 may use a learning rate A to update the transforms Rₖ^{(p)}, Tₖ^{(p)} for every joint, which will be the values for the next iteration. For instance, the transforms may be updated according to equations (13) and (14).

Block 714 may be followed by block 716. At block 716, a final rotational transform and a final translational transform for joint k may be determined based on the rotational transform Rₖ^{(p)} and the translational transform Tₖ^{(p)} updated based on the learning rate λ. For example, referring to FIG. 5, the SSDR component 210 may determine the final rotational transform and a final translational transform for joint k once all iterations are performed.

At block 718, a set of final skinning weights may be determined for each vertex-joint pair in the set of vertex-joint pairs based on the final rotational transform and the final translational transform for each joint k of the plurality of joints J. For example, referring to FIG. 5, the SSDR component 210 may solve for the final skinning weights wᵢⱼ while holding the joint transforms, constant Rⱼ^{(p)}, Tⱼ^{(p)} for every joint j=1, . . . , J and poses p=1, . . . , P, constant.

Block 718 may be followed by block 720. At block 720, an avatar head may be rendered based in the pose p based on the final rotational transform and the final translational transform. For example, referring to FIG. 5, rigged/caged head component 218 may receive the LBS rig from the SSDR component 210. Using the LBS rig, the rigged/caged head component 218 may animate the avatar's face and head.

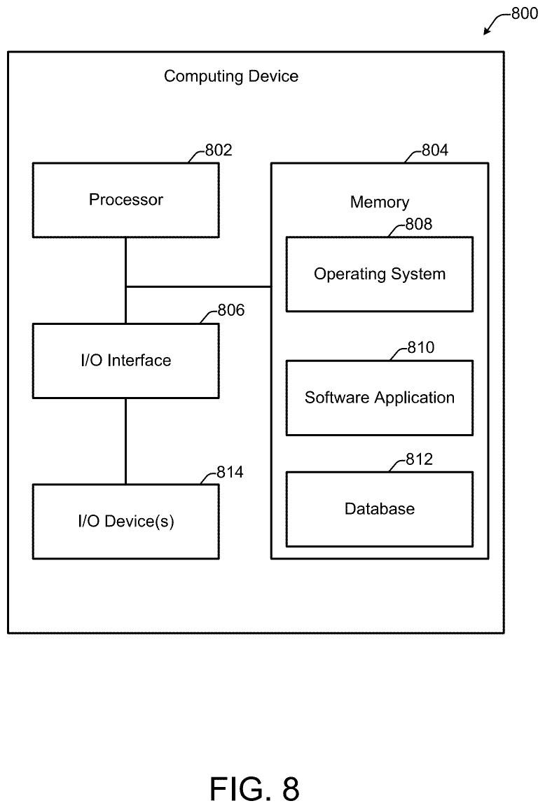

### FIG. 8: Computing Devices

Hereinafter, a more detailed description of various computing devices that may be used to implement different devices and/or components illustrated in FIG. 1 is provided with reference to FIG. 8.

FIG. 8 is a block diagram of an example computing device 800 which may be used to implement one or more features described herein, in accordance with some implementations. In one example, device 800 may be used to implement a computer device, (e.g., 102, 110 of FIG. 1), and perform appropriate operations as described herein. Computing device 800 can be any suitable computer system, server, or other electronic or hardware device. For example, the computing device 800 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 800 includes a processor 802, a memory 804, input/output (I/O) interface 806, and audio/video input/output devices 814 (e.g., display screen, touchscreen, display goggles or glasses, audio speakers, headphones, microphone, etc.).

Processor 802 can be one or more processors and/or processing circuits to execute program code and control basic operations of the device 800. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 804 is typically provided in device 800 for access by the processor 802, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 802 and/or integrated therewith. Memory 804 can store software operating on the server device 800 by the processor 802, including an operating system 808, software application 810 and associated database 812. In some implementations, the applications 810 can include instructions that enable processor 802 to perform the functions described herein. Software application 810 may include some or all of the functionality required to compute an LBS rig and a head cage for an avatar head based on its head mesh. In some implementations, one or more portions of software application 810 may be implemented in dedicated hardware such as an application-specific integrated circuit (ASIC), a programmable logic device (PLD), a field-programmable gate array (FPGA), a machine learning processor, etc. In some implementations, one or more portions of software application 810 may be implemented in general purpose processors, such as a central processing unit (CPU) or a graphics processing unit (GPU). In various implementations, suitable combinations of dedicated and/or general-purpose processing hardware may be used to implement software application 810.

For example, software application 810 stored in memory 804 can include instructions for retrieving user data, for displaying/presenting avatars heads or head parts, and/or other functionality or software such as the avatar-head modeling component 130, virtual experience (VE) engine 104, and/or virtual experience application 112. Any of the software in memory 804 can alternatively be stored on any other suitable storage location or computer-readable medium. In addition, memory 804 (and/or other connected storage device(s)) can store instructions and data used in the features described herein. Memory 804 and any other type of storage (magnetic disk, optical disk, magnetic tape, or other tangible media) can be considered “storage” or “storage devices.”

I/O interface 806 can provide functions to enable interfacing the server device 800 with other systems and devices. For example, network communication devices, storage devices (e.g., memory and/or data store 106), and input/output devices can communicate via interface 806. In some implementations, the I/O interface can connect to interface devices including input devices (keyboard, pointing device, touchscreen, microphone, camera, scanner, etc.) and/or output devices (display device, speaker devices, printer, motor, etc.).

For ease of illustration, FIG. 8 shows one block for each of processor 802, memory 804, I/O interface 806, operating system 808, software application 810, and database 812. These blocks may represent one or more processors or processing circuitries, operating systems, memories, I/O interfaces, applications, and/or software modules. In other implementations, device 800 may not have all of the components shown and/or may have other elements including other types of elements instead of, or in addition to, those shown herein. While the online virtual experience server 102 are described as performing operations as described in some implementations herein, any suitable component or combination of components of online virtual experience server 102, or similar system, or any suitable processor or processors associated with such a system, may perform the operations described.

A user device can also implement and/or be used with features described herein. Example user devices can be computer devices including some similar components as the device 800, e.g., processor(s) 802, memory 804, and I/O interface 806. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 814, for example, can be connected to (or included in) the device 800 to display images pre- and post-processing as described herein, where such display device can include any suitable display device, e.g., an liquid crystal display (LCD), light-emitting diode (LED), or plasma display screen, cathode ray tube (CRT), television, monitor, touchscreen, 3D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., method 700) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to generate a linear blend skinning (LBS) rig for animation, comprising:
for each pose p of a plurality of poses P and for each joint k of a plurality of joints J,
determining, by a processor, a set of vertex-joint pairs in which a joint j of the plurality of joints J has influence over a vertex i in the pose p;
determining, by the processor, a corresponding first LBS coefficient β_{i,j}^{(p)} for each vertex-joint pair in the set of vertex-joint pairs based on a rotational transform Rⱼ^{(p)} of the joint j, an initial vertex position vᵢ⁽⁰⁾ of the vertex i in a neutral pose, and a translational transform Tⱼ^{(p)} of the joint j;
determining, by the processor, a corresponding second LBS coefficient γᵢ^{(p)} for each vertex i in the set of vertex-joint pairs by summing first LBS coefficients β_{i,j}^{(p)} for each vertex-joint pair that correspond to that respective vertex i, where i=1, . . . , N, where Nis a total number of vertices;
determining, by the processor, a corresponding third LBS coefficient α_{i,k}^{(p)} for each vertex i and each joint k based on a final vertex position vᵢ^{(p)} of the vertex i in the pose p, and the corresponding second LBS coefficient γᵢ^{(p)} for vertex i, and a fourth LBS coefficient β_{i,k}^{(p)} corresponding to the vertex i and the joint k;
determining, by the processor, a rotational transform Rₖ^{(p)} and a translational transform Tₖ^{(p)} for the joint k based on the corresponding third LBS coefficient α_{i,k}^{(p)} for the joint k;
updating, by the processor, the rotational transform Rₖ^{(p)} and the translational transform Tₖ^{(p)} for each joint k based on a learning rate λ; and
determining, by the processor, a final rotational transform and a final translational transform for joint k based on the rotational transform and the translational transform updated based on the learning rate λ; and
rendering, by the processor, an avatar head based in the pose p based on the final rotational transform and the final translational transform.

2. The method of claim 1, further comprising, for each pose p of a plurality of poses P and for each joint k of a plurality of joints J:
determining, by the processor, a set of final skinning weights for each vertex-joint pair in the set of vertex-joint pairs based on the final rotational transform and the final translational transform for each joint k of the plurality of joints J.

3. The method of claim 1, wherein determining the set of vertex-joint pairs in which a joint j of the plurality of joints J has influence over the vertex i in the pose p comprises:
determining, by the processor, a feature vector for the vertex i based on the initial vertex position vᵢ⁽⁰⁾ of the vertex i in the neutral pose and the final vertex position vᵢ^{(p)} of the vertex i in the pose p for each of the plurality of poses P, the set of vertex-joint pairs being determined based on the feature vector.

4. The method of claim 1, further comprising:
assigning, by the processor, an initial skinning weight wᵢⱼ to each vertex-joint pair in the set of vertex-joint pairs to a value of 1.

5. The method of claim 4, wherein the corresponding first LBS coefficient β_{i,j}^{(p)} for each vertex-joint pair in the set of vertex-joint pairs is determined by solving β_{i,j}^{(p)}=wᵢⱼ(Rⱼ^{(p)}vᵢ⁽⁰⁾+Tⱼ^{(p)}).

6. The method of claim 5, wherein the corresponding second LBS coefficient γᵢ^{(p)} for each vertex i in the set of vertex-joint pairs is determined by solving
$${γ}_{i}^{( p )} = {\sum }_{j : {w}_{ij} > 0} {β}_{i , j}^{( p )} .$$

7. The method of claim 6, wherein the corresponding third LBS coefficient α_{i,k}^{(p)} for each vertex i and each joint k is determined by solving α_{i,k}^{(p)}=vᵢ^{(p)}−γᵢ^{(p)}+β_{i,k}^{(p)}.

8. The method of claim 7, wherein the rotational transform Rₖ^{(p)} and a translational transform Tₖ^{(p)} for the joint k is determined based on
$${min}_{{R}_{k}^{( p )} , {T}_{k}^{( p )}} {w}_{ik}^{2} {‖ ( {R}_{k}^{( p )} {v}_{i}^{( 0 )} + {T}_{k}^{( p )} ) - \frac{{α}_{i , k}^{( p )}}{{w}_{ik}} ‖}^{2} .$$

9. A computing device to generate a linear blend skinning (LBS) rig for animation, comprising:
a processor; and
a memory, coupled to the processor and storing instructions, which when executed by the processor, cause the processor to perform operations comprising:
for each pose p of a plurality of poses P and for each joint k of a plurality of joints J,
determining a set of vertex-joint pairs in which a joint j of the plurality of joints J has influence over a vertex i in the pose p;
determining a corresponding first LBS coefficient β_{i,j}^{(p)} for each vertex-joint pair in the set of vertex-joint pairs based on a rotational transform Rⱼ^{(p)} of the joint j, an initial vertex position vᵢ⁽⁰⁾ of the vertex i in a neutral pose, and a translational transform Tⱼ^{(p)} of the joint j;
determining a corresponding second LBS coefficient γᵢ^{(p)} for each vertex i in the set of vertex-joint pairs by summing first LBS coefficients β_{i,j}^{(p)} for each vertex-joint pair that correspond to that respective vertex i, where i=1, . . . , N, where N is a total number of vertices;
determining a corresponding third LBS coefficient α_{i,k}^{(p)} for each vertex i and each joint k based on a final vertex position vᵢ^{(p)} of the vertex i in the pose p, and the corresponding second LBS coefficient γᵢ₍ₚ₎ for vertex i, and a fourth LBS coefficient β_{i,k}^{(p)} corresponding to the vertex i and the joint k;
determining a rotational transform Rₖ^{(p)} and a translational transform \hat{T}ₖ^{(p)} for the joint k based on the corresponding third LBS coefficient α_{i,k}^{(p)} for the joint k;
updating the rotational transform Rₖ^{(p)} and the translational transform \hat{T}ₖ^{(p)} for each joint k based on a learning rate λ; and
determining a final rotational transform and a final translational transform for joint k based on the rotational transform Rₖ^{(p)} and the translational transform Tₖ^{(p)} updated based on the learning rate λ; and
rendering an avatar head based in the pose p based on the final rotational transform and the final translational transform.

10. The computing device of claim 9, wherein the operations further comprise, for each pose p of a plurality of poses P and for each joint k of a plurality of joints J:
determining a set of final skinning weights for each vertex-joint pair in the set of vertex-joint pairs based on the final rotational transform and the final translational transform for each joint k of the plurality of joints J.

11. The computing device of claim 9, wherein determining the set of vertex-joint pairs in which a joint j of the plurality of joints J has influence over the vertex i in the pose p comprises:
determining a feature vector for the vertex i based on the initial vertex position vᵢ⁽⁰⁾ of the vertex i in the neutral pose and the final vertex position vᵢ^{(p)} of the vertex i in the pose p for each of the plurality of poses P, the set of vertex-joint pairs being determined based on the feature vector.

12. The computing device of claim 9, wherein the operations further comprise:
assigning an initial skinning weight wᵢⱼ to each vertex-joint pair in the set of vertex-joint pairs to a value of 1.

13. The computing device of claim 12, wherein the corresponding first LBS coefficient β_{i,j}^{(p)} for each vertex-joint pair in the set of vertex-joint pairs is determined by solving β_{i,j}^{(p)}=wᵢⱼ(Rⱼ^{(p)}vᵢ⁽⁰⁾+Tⱼ^{(p)}).

14. The computing device of claim 13, wherein the corresponding second LBS coefficient γᵢ^{(p)} for each vertex i in the set of vertex-joint pairs is computed by solving
$${γ}_{i}^{( p )} = {\sum }_{j : {w}_{ij} > 0} {β}_{i , j}^{( p )} .$$

15. The computing device of claim 14, wherein the corresponding third LBS coefficient α_{i,k}^{(p)} for each vertex i and each joint k is determined by solving α_{i,k}^{(p)}=vᵢ^{(p)}−γᵢ^{(p)}+β_{i,k}^{(p)}.

16. The computing device of claim 15, wherein the rotational transform Rₖ^{(p)} and a translational transform Tₖ^{(p)} for the joint k based on
$${min}_{{R}_{k}^{( p )} , {T}_{k}^{( p )}} {w}_{ik}^{2} {‖ ( {R}_{k}^{( p )} {v}_{i}^{( 0 )} + {T}_{k}^{( p )} ) - \frac{{α}_{i , k}^{( p )}}{{w}_{ik}} ‖}^{2} .$$

17. A non-transitory computer-readable medium storing instructions, which when executed by a processor, cause the processor to perform operations comprising:
for each pose p of a plurality of poses P and for each joint k of a plurality of joints J,
determining a set of vertex-joint pairs in which a joint j of the plurality of joints J has influence over a vertex i in the pose p;
determining a corresponding first LBS coefficient β_{i,j}^{(p)} for each vertex-joint pair in the set of vertex-joint pairs based on a rotational transform Rⱼ^{(p)} of the joint j, an initial vertex position vᵢ⁽⁰⁾ of the vertex i in a neutral pose, and a translational transform Tⱼ^{(p)} of the joint j;
determining a corresponding second LBS coefficient γᵢ^{(p)} for each vertex i in the set of vertex-joint pairs by summing first LBS coefficients β_{i,j}^{(p)} for each vertex-joint pair that correspond to that respective vertex i, where i=1, . . . , N, where Nis a total number of vertices;
determining a corresponding third LBS coefficient α_{i,k}^{(p)} for each vertex i and each joint k based on a final vertex position vᵢ^{(p)} of the vertex i in the pose p, and the corresponding second LBS coefficient γᵢ^{(p)} for vertex i, and a fourth LBS coefficient Buk corresponding to the vertex i and the joint k;
determining a rotational transform Rₖ^{(p)} and a translational transform Tₖ^{(p)} for the joint k based on the corresponding third LBS coefficient α_{i,k}^{(p)} for the joint k;
updating the rotational transform Rₖ^{(p)} and the translational transform Tₖ^{(p)} for each joint k based on a learning rate λ; and
determining a final rotational transform and a final translational transform for joint k based on the rotational transform Rₖ^{(p)} and the translational transform Tₖ^{(p)} updated based on the learning rate λ; and
rendering an avatar head based in the pose p based on the final rotational transform and the final translational transform.

18. The apparatus of claim 17, wherein determining the set of vertex-joint pairs in which a joint j of the plurality of joints J has influence over the vertex i in the pose p, the instructions, which when executed by the processor comprises:
determining a feature vector for the vertex i based on the initial vertex position vᵢ⁽⁰⁾ of the vertex i in the neutral pose and the final vertex position vᵢ^{(p)} of the vertex i in the pose p for each of the plurality of poses P, the set of vertex-joint pairs being determined based on the feature vector.

19. The apparatus of claim 17, wherein the operations further comprise:
assigning an initial skinning weight wᵢⱼ to each vertex-joint pair in the set of vertex-joint pairs to a value of 1.

20. The apparatus of claim 19, wherein:
the corresponding first LBS coefficient β_{i,j}^{(p)} for each vertex-joint pair in the set of vertex-joint pairs is determined by solving β_{i,j}^{(p)}=wᵢⱼ(Rⱼ^{(p)}vᵢ⁽⁰⁾+Tⱼ^{(p)}),
the corresponding second LBS coefficient γᵢ^{(p)} for each vertex i in the set of vertex-joint pairs is computed by solving
$${γ}_{i}^{( p )} = {\sum }_{j : {w}_{ij} > 0} {β}_{i , j}^{( p )} ,$$
the corresponding third LBS coefficient α_{i,k}^{(p)} for each vertex i and each joint k is determined by solving α_{i,k}^{(p)}=vᵢ^{(p)}−γᵢ^{(p)}+β_{i,k}^{(p)}, and
the rotational transform \hat{R}ₖ^{(p)} and a translational transform \hat{T}ₖ^{(p)} for the joint k is determined based on
$${min}_{{R}_{k}^{( p )} , {T}_{k}^{( p )}} {w}_{ik}^{2} {‖ ( {R}_{k}^{( p )} {v}_{i}^{( 0 )} + {T}_{k}^{( p )} ) - \frac{{α}_{i , k}^{( p )}}{{w}_{ik}} ‖}^{2} .$$
